(19) United States
(12) Patent Application Publication
(10) Pub. No.: US 2013/0070734 A1
(43) Pub. Date: Mar. 21, 2013

(54) NETWORK APPARATUS FOR ACCESSING CHANNEL IN CONTENTION FREE PERIOD

(71) Applicants: Sung Ho Hwang, Suwon (KR); Bo Yle Seo, Gunpo (KR)

(72) Inventors: Sung Ho Hwang, Suwon (KR); Bo Yle Seo, Gunpo (KR)

(73) Assignee: SAMSUNG ELECTRO-MECHANICS CO., LTD.

(21) Appl. No.: 13/324,386

(22) Filed: Dec. 13, 2011

(30) Foreign Application Priority Data
Sep. 16, 2011 (KR) 10-2011-0093471

(51) Int. Cl. H04W 72/12

(52) U.S. Cl. 370/336

(57) ABSTRACT

There is provided a network apparatus in which a contention free period is fixed at a relatively maximum size and guaranteed time slots are varied in the fixed contention free period to allocate remaining time slots of the contention free period to data transmissions of terminals according to priority. There is provided a network apparatus for accessing a channel in a contention free period, the method including: a coordinator fixing a contention free period within a frame to have a preset size and setting and allocating guaranteed time slots (GTSs) in the fixed contention free period according to request; and a terminal group having at least one terminal, forming a network with the coordinator, requesting guaranteed time slots from the coordinator, and transmitting data in allocated guaranteed time slots.

### CROSS-REFERENCE TO RELATED APPLICATIONS

This application claims the priority of Korean Patent Application No. 10-2011-0093471 filed on Sep. 16, 2011, in the Korean Intellectual Property Office, the disclosure of which is incorporated herein by reference.

### BACKGROUND OF THE INVENTION

1. Field of the Invention

The present invention relates to a network apparatus for accessing a channel in a contention free period.

2. Description of the Related Art

Recently, a ZigBee network based on the IEEE 802.15.4 standard has come to prominence as a wireless communications network technology for industrial control, disaster management, ubiquitous health care using a biosensor, or the like, and for use in an intelligent power network known as a smart grid, due to characteristics such as low cost and low power consumption at a low speed transmission of the ZigBee network.

This ZigBee network, based on the IEEE 802.15.4 standard, may be configured as a network for industrial applications, home applications, or the like, due to low power consumption and low configuration costs in a local area, and may be applied to a home area network (HAN) in a smart grid field.

The above-mentioned HAN refers to a network between final smart devices having a ZigBee communication module mounted therein in a home. This network may be connected to an external network through an advanced metering infrastructure (AMI).

Meanwhile, in this ZigBee communications-type channel access method, a beacon is mainly used. A terminal communicates with a coordinator in a slotted-CSNA/CA scheme, and backoff, or the like, for solving defects such as collisions with other terminals may be arranged by transmitting the beacon.

This coordinator periodically broadcasts a beacon frame to devices within a network to provide synchronization between terminals, network identification, and a structure of a superframe. In a structure of the frame, a period in which the terminals may transmit data is configured as a contention access period (CAP) or a contention free period (CFP). The contention free period may be varied according to transmitted data.

However, in the field of smart grids, a case in which data should be transmitted in real time is frequently generated. In this situation, when multiple terminals use the contention access period, collisions therebetween may occur. In addition, when the terminals use the contention free period, the data is transmitted in a sequence of transmission attempts by the terminals, such that a delay is generated.

### SUMMARY OF THE INVENTION

An aspect of the present invention provides a network apparatus in which a contention free period is fixed at a relatively maximum size and guaranteed time slots are varied therein to allocate remaining time slots of the contention free period to data transmissions of terminals according to priority.

According to an aspect of the present invention, there is provided a network apparatus for accessing a channel in a contention free period, the method including: a coordinator fixing the contention free period within a frame to have a preset size and setting and allocating guaranteed time slots (GTSs) in the fixed contention free period according to request; and a terminal group having at least one terminal, forming a network with the coordinator, requesting guaranteed time slots from the coordinator, and transmitting data in allocated guaranteed time slots.

The contention free period may be fixed at a relatively maximum size within the frame such that the channel is accessed therein.

The coordinator may allocate slots remaining after the guaranteed time slots are allocated in the contention free period of the frame to other terminals of the terminal groups according to a preset priority.

The coordinator may determine remaining slots using a size of the contention free period, a size of the frame, a size of the contention access period within the frame, and a size of the allocated guaranteed time slots.

The priority may be set according to at least one of the amount or frequency of data that the terminals of the terminal group are to transmit in real time.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view showing a method of accessing a channel in a network apparatus according to an embodiment of the present invention;

FIG. 2 is a configuration view of a frame used in the network apparatus according to the embodiment of the present invention; and

FIG. 3 is a view showing a method of accessing a channel according to priority in the network apparatus according to the embodiment of the present invention.

### DETAILED DESCRIPTION OF THE INVENTION

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

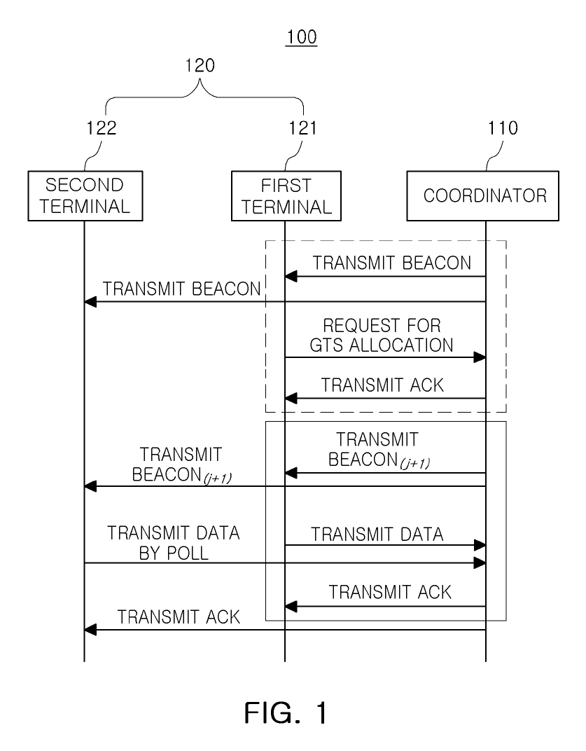

FIG. 1 is a view showing a method of accessing a channel of a network apparatus according to an embodiment of the present invention.

Referring to FIG. 1, a network apparatus 100 according to the embodiment of the present invention may include a coordinator 110 and a terminal group 120.

The coordinator 110 may communicate with each terminal of the terminal group 120 wirelessly to thereby form a network, and may coordinate data transmissions of terminals within the network.

To this end, the coordinator 110 may broadcast a beacon to allocate a slot such that the terminals may transmit the data.

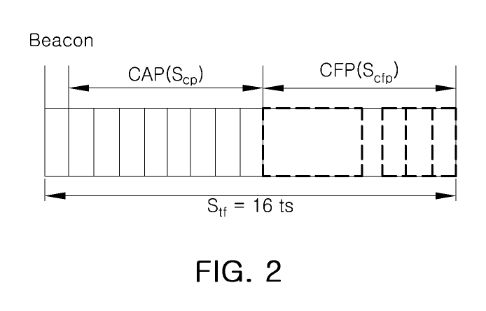

FIG. 2 is a configuration view of a frame used in the network apparatus, according to the embodiment of the present invention.

Referring to FIGS. 1 and 2, the coordinator 110 may broadcast the beacon to allocate the slot so that the terminals may transmit data. Here, a structure of a frame transceived in the wireless communication may be set as shown in FIG. 2.

That is, the frame may be set to a contention access period (CAP) and a contention free period (CFP). Here, each terminal may contend in order to use the contention access period. When a collision occurs in the contention access period, it may be solved by backoff. However, each terminal needs to attempt transmission in the contention access period of each frame.

In the contention free period, guaranteed time slots may be set at the request of a terminal, and the coordinator 110 may transmit data to the terminal requesting the guaranteed time slots during the guaranteed time slots.

More specifically, the coordinator 110 may broadcast a beacon, beaconᵢ, indicating whether or not a terminal requesting the guaranteed time slots is present. For example, the first terminal 121 of the terminal group 120 may request guaranteed time slots (GTS) from the coordinator 110, and the coordinator 110 may transmit an acknowledge (ACK) to the request to the first terminal 121 requesting the guaranteed time slots.

Then, the coordinator 110 may broadcast a beacon, beacon₍ⱼ₊₁₎, containing frame information configured according to the request, and the first terminal 121 may transmit data in the guaranteed time slots (GTSs) allocated according to the information contained in the beacon, beacon₍ⱼ₊₁₎.

Meanwhile, the contention free period may be fixed at a preset size, and may be fixed at a relatively maximum size.

For example, when the contention access period (CAP) and the contention free period (CFP) have a total of 16 time slots in a single frame, the contention access period may be set to have 8 time slots, and the contention free period may be set to have 8 remaining time slots.

Here, the guaranteed time slots (GTSs) may be variably set, and the variable size of the guaranteed time slots (GTSs) may be determined according to an amount of data that the terminal requesting the guaranteed time slots is to transmit.

For example, when the first terminal 121 requests 4 time slots from the coordinator 110 to be allocated as guaranteed time slots (GTSs), the remaining 4 time slots may not be allocated in the contention free period.

Here, another terminal of the terminal group 120 may transmit data in non-allocated time slots according to a preset priority.

The coordinator 110 may determine remaining slots using a size of the contention free period, a size of the frame, a size of the contention access period within the frame, and a size of allocated guaranteed time slots, represented by the following Equation.

(Equation)

S_{cp}=S_{tf}−S_{ctp}(S_{tf}=16)

Sₚ=S_{cfp}−S_{g}

Where Scp is a size of the contention access period, Stf is a size of the frame (for example, that may be assumed as 16 time slots), Scfp is a size of the contention free period, Sg is a size of allocated guaranteed time slots, and Sp is a size of non-allocated time slots, that is, a size of an amount of data that may be transmitted by the terminals according to priority.

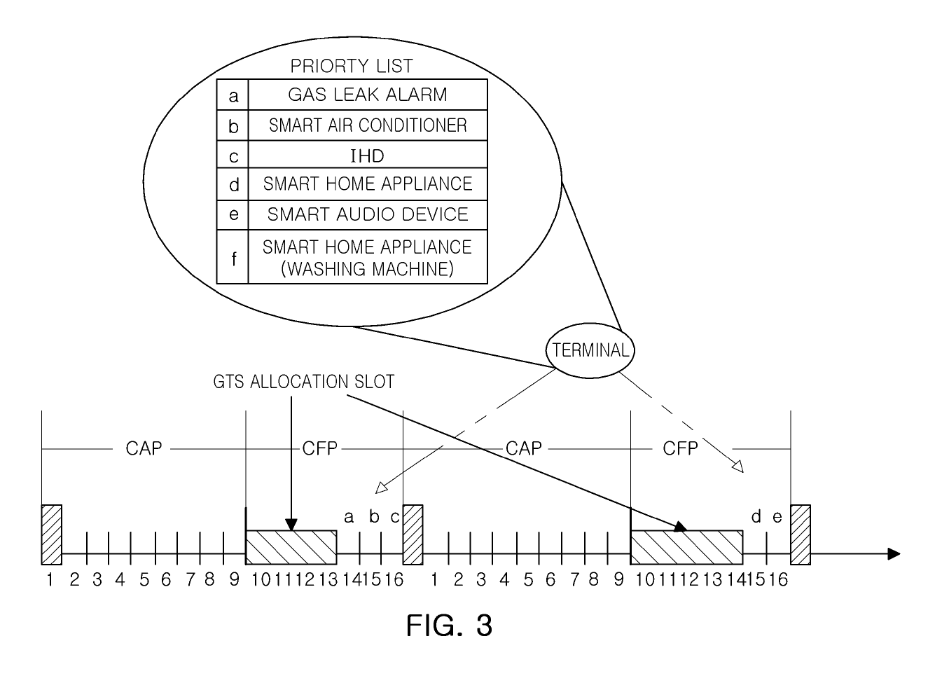

FIG. 3 is a view showing a method of accessing a channel according to priority in the network apparatus according to the embodiment of the present invention.

Referring to FIGS. 1 through 3, when the coordinator 110 of the network apparatus 100 according to the embodiment of the present invention allocates 5 time slots as guaranteed time slots (GTSs) according to the request of the first terminal 121, 3 time slots among a total of 8 time slots of the contention free period (CFP) may be used for data transmission by terminals, according to the priority.

Terminals according to the priority may be set according to priority list set according to at least one of the amount or frequency of data that the terminals of the terminal group are to transmit in real time.

For example, in the priority list, priority may be set in a sequence of a gas leak alarm that first needs to transmit data when data to be transmitted is generated in a home network of a smart grid environment, a smart air conditioner, a smart meter in a home display (IHD) displaying power consumption, a television, an audio device, a smart home appliance such as a washing machine, or the like, as shown in FIG. 3.

As described above, according to the embodiments of the present invention, the contention free period may be fixed at a relatively maximum size and the guaranteed time slots may be varied in the fixed contention free period to allocate remaining time slots of the contention free period to the data transmission of the terminals according to the priority, whereby a limited wireless channel may be efficiently used and wireless communication of the terminals requiring real-time data transmission such as in the case of a gas leak or air conditioning in the home network of the smart grid environment may be smoothly guaranteed.

While the present invention has been shown and described in connection with the exemplary embodiments, it will be apparent to those skilled in the art that modifications and variations can be made without departing from the spirit and scope of the invention as defined by the appended claims.

What is claimed is:

1. A network apparatus for accessing a channel in a contention free period, the method comprising:
a coordinator fixing the contention free period within a frame to have a preset size and setting and allocating guaranteed time slots (GTSs) in the fixed contention free period according to request; and
a terminal group having at least one terminal, forming a network with the coordinator, requesting guaranteed time slots from the coordinator, and transmitting data in allocated guaranteed time slots.

2. The apparatus of claim. 1, wherein the contention free period is fixed at a relatively maximum size within the frame such that the channel is accessed therein.

3. The apparatus of claim 2, wherein the coordinator allocates slots remaining after the guaranteed time slots are allocated in the contention free period of the frame to other terminals of the terminal groups according to a preset priority.

4. The apparatus of claim 3, wherein the coordinator determines remaining slots using a size of the contention free period, a size of the frame, a size of the contention access period within the frame, and a size of the allocated guaranteed time slots.

5. The apparatus of claim 3, wherein the priority is set according to at least one of the amount or frequency of data that the terminals of the terminal group are to transmit in real time.
